(19) United States
(12) Patent Application Publication
(10) Pub. No.: US 2016/0377405 A1
(43) Pub. Date: Dec. 29, 2016

(54) MEASURING TOOL FOR BUILDINGS

(71) Applicant: Ming-Hsiung Chen, Taipei City (TW)

(72) Inventor: Ming-Hsiung Chen, Taipei City (TW)

(21) Appl. No.: 14/747,830

(22) Filed: Jun. 23, 2015

(51) Int. Cl. G01B 5/06; G01B 3/28

(52) U.S. Cl. CPC G01B 5/066; G01B 3/28

(57) ABSTRACT

A measuring tool for buildings comprises a body, an electronic reading device, and a probe. The body has a plate, and the plate has two ends and a pushing part. The pushing part is formed on one of the ends of the plate. The electronic reading device is slidably mounted on the plate of the body. The probe is connected to the body and the electronic reading device and has a sharp end and a connecting end. The sharp end of the probe is mounted through the pushing part of the plate. The connecting end of the probe is connected to the electronic reading device.

### BACKGROUND OF THE INVENTION

1. Field of the Invention

The present invention relates to a measuring tool, especially a measuring tool that measures thickness of a fire resistant layer coated on a steel beam. The measuring tool is also applicable for measuring thickness of a spray-coated acoustic material or a foamed material.

2. Description of the Prior Arts

A modern steel-skeleton building has a fire resistant layer coated on an outer surface of steel. The main objective is to defer softening of the steel caused by high temperature when the steel-skeleton building is on fire. After the steel is heated and softened, the steel-skeleton building will quickly collapse without support of the steel, so the fire resistant layer is to prevent the fire from directly heating the steel for prolonging the fire resistance period of the steel, such that people in the building have enough time to evacuate. In addition, when on fire, the steel-skeleton building can sustain for a period of time against collapsing before the fire is extinguished.

Therefore, a thickness of the fire resistant layer affects the initial softening time of the steel when the steel is heated. To reach the premise of prolonging the fire resistance period, the thickness of the fire resistant layer should not be too large otherwise a load of the steel-skeleton building is increased. So the thickness of the fire resistant layer must accord with interrelated building technical regulations and testing data of the fire resistant layer.

With reference to FIGS. 5 and 6, a conventional measuring tool to measure a thickness of a fire resistant layer has a ruler 40, a measuring device 50, and a fixing member 60. The ruler 40 has scales of length, two ends, a pushing part 41, and a limiting part 42. The pushing part 41 and the limiting part 42 are respectively formed on two ends of the ruler 40. The measuring device 50 has a probe 51 and a reference base 52. The probe 51 has a sharp end and a connecting end. The sharp end of the probe 51 is mounted through the pushing part 41. The reference base 52 is slidably mounted on the ruler 40. The connecting end of the probe 51 is connected to the reference base 52. The fixing member 60 is mounted around the ruler 40 to limit the probe 51 sliding on the ruler 40. The pushing part 41 is a circular sheet and is perpendicularly connected to the ruler 40. The limiting part 42 is used to prevent the measuring device 50 from escaping from the ruler 40.

When the conventional measuring tool is implemented, the conventional measuring tool is operated by a group of inspection personnel. One of the inspection personnel holds the measuring tool and makes the pushing part 41 of the ruler 40 abut on a surface of the fire resistant layer 80 coated on the steel beam 70, and pushes the reference base 52. The reference base 52 is slid along the ruler 40, and the sharp end of the probe 51 is inserted into the fire resistant layer 80 to touch the steel beam 70. Said inspection personnel could obtain the thickness of the fire resistant layer 80 by reading the scale corresponding to a reference end 521 of the reference base 52, and another inspection personnel could record thickness data of the fire resistant layer 80.

However, the measuring data of the conventional measuring tool relies on human eyes to read the scale corresponding to the reference end 521 of the reference base 52. Therefore, the ruler is difficult to read such that the measuring data of the ruler 40 might be erroneously read by the inspection personnel during the measuring process, and the measuring data of the ruler 40 is not precise enough. In addition, the measuring process needs at least one personnel besides the personnel who holds the measuring tool to record the measuring data, so the measuring process of the conventional measuring tool is time-consuming and labor-intensive.

To overcome the shortcomings, the present invention provides a measuring tool for buildings to mitigate or obviate the aforementioned problems.

### SUMMARY OF THE INVENTION

The main objective of the present invention is to provide a measuring tool for buildings that improves shortcomings of difficult reading, low precision of measuring data, time-consuming recording, and labor-intensiveness.

The measuring tool for buildings comprises a body, an electronic reading device, and a probe. The body has a plate, and the plate is elongated in an axial direction and has two ends and a pushing part. The pushing part is formed on one of the ends of the plate. The electronic reading device is slidably mounted on the plate of the body and is selectively moved along the plate of the body. The probe is connected to the body and the electronic reading device and has a sharp end and a connecting end. The sharp end of the probe is mounted through the pushing part of the plate. The connecting end of the probe is connected to the electronic reading device.

Other objectives, advantages and novel features of the invention will become more apparent from the following detailed description when taken in conjunction with the accompanying drawings.

### BRIEF DESCRIPTION OF THE DRAWINGS

FIG. 1 is a front view of a measuring tool for buildings in accordance with the present invention;

FIG. 2 is a top view of the measuring tool for buildings in FIG. 1;

FIG. 3 is a front view of another embodiment of a measuring tool for buildings in accordance with the present invention;

FIG. 4 is a rear view of the measuring tool for buildings in FIG. 3;

FIG. 5 is front view of a conventional measuring tool; and

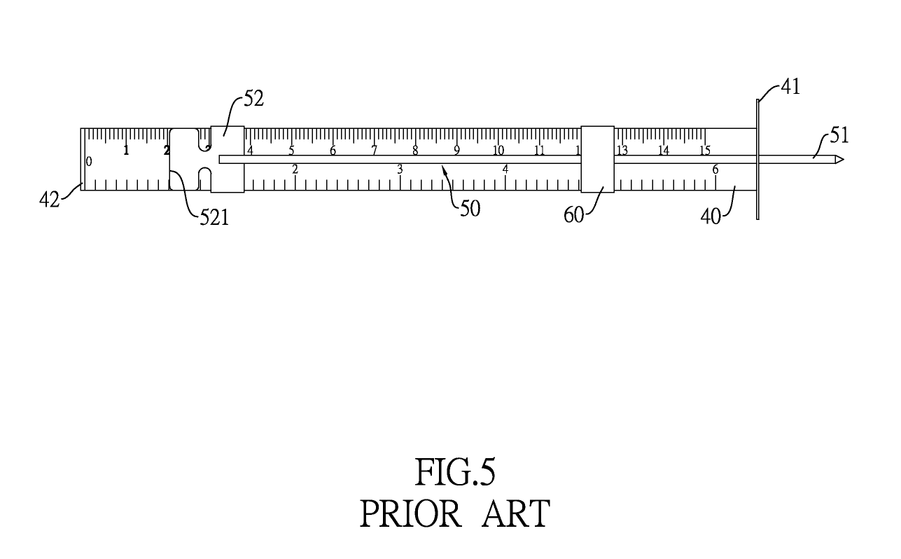

FIG. 6 is a schematic operational view of the conventional measuring tool in FIG. 5.

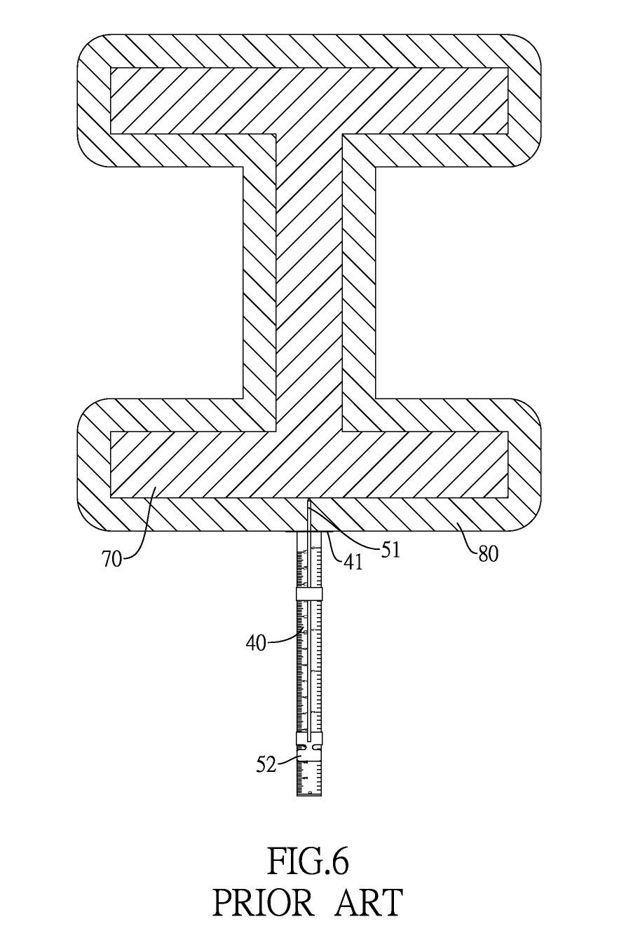

### DETAILED DESCRIPTION OF THE PREFERRED EMBODIMENTS

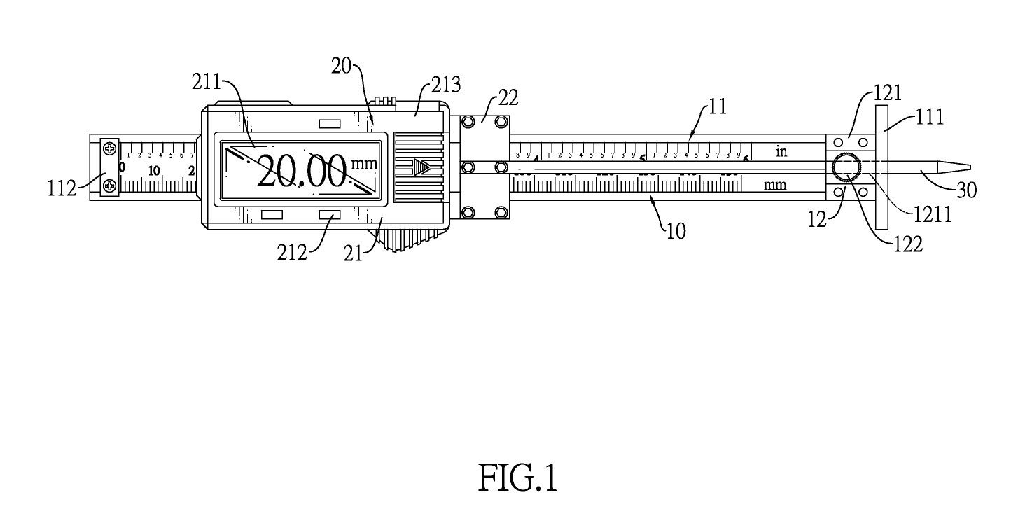

With reference to FIGS. 1 to 3, a measuring tool for buildings in accordance with the present invention comprises a body 10, an electronic reading device 20, and a probe 30.

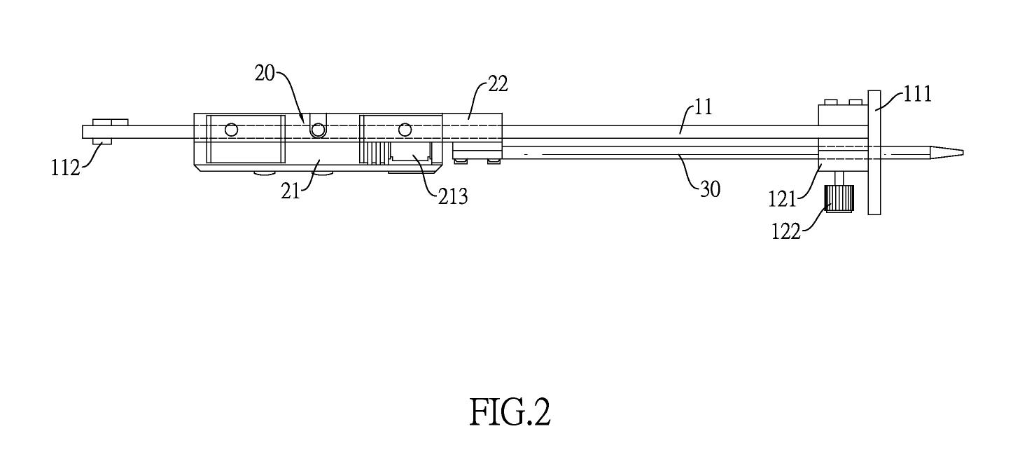

With reference to FIGS. 1 and 2, the body 10 has a plate 11. The plate 11 is elongated in an axial direction, and has a marking surface, two ends, a pushing part 111, and a limiting part 112. The pushing part 111 is perpendicularly connected to one of the ends of the plate 11 and has a pinhole. The limiting part 112 is securely connected to the other end of the plate 11. The plate 11 further has scales marked on the marking surface of the plate 111.

The body 10 further has a positioning member 12. The positioning member 12 is mounted on the plate 11 and near the pushing part 111. The positioning member 12 has a stationary block 121 and a resisting screw 122. The stationary block 121 is mounted on the plate 11, and the stationary block 121 has a through hole 1211 and a threaded hole. The through hole 1211 is formed through the stationary block 121 and parallel with the axial direction of the plate 11. The threaded hole is formed in the stationary block 121 and communicates with the through hole 1211. The resisting screw 122 is screwed with the threaded hole of the stationary block 121. The resisting screw 122 has a resisting end selectively mounted in the through hole 1211 of the stationary block 121.

With reference to FIGS. 1 and 2, the electronic reading device 20 is slidably mounted on the plate 11 of the body 10. The electronic reading device 20 has a measuring instrument 21 and an installing base 22.

The measuring instrument 21 is mounted on and abuts the plate 11, and has a screen 211, multiple buttons 212, and a communication port 213. The screen 211 is mounted on and electrically connected to the measuring instrument 21. The buttons 212 are mounted on the measuring instrument 21 and near the screen 211. The communication port 213 is mounted on and electrically connected to the measuring instrument 21. The signal transmission ??

of the communication port 213 is via USB (Universal Serial Bus) interface, wireless transmission, or wired transmission.

The installing base 22 has a recess 221. The plate 11 is slidably mounted through the recess 221. The installing base 22 is connected to the measuring instrument 21 and faces the pushing part 111 of the plate 11.

The probe 30 is connected to the body 10 and the electronic reading device 20 and has a sharp end and a connecting end. The sharp end of the probe 30 is mounted through the pinhole of the pushing part 111 of the plate 11. The through hole 1211 of the stationary block 121 is disposed around the sharp end of the probe 30. The connecting end of the probe 30 is connected to the installing base 22 of the electronic reading device 20. When the sharp end of the probe 30 is passed through the through hole 1211 of the stationary block 121, the resisting screw 122 can selectively abut the probe 30 to keep a stationary position relative to the plate 11 of the probe 30. The resisting screw 122 is a hexangular screw for retaining the probe 30.

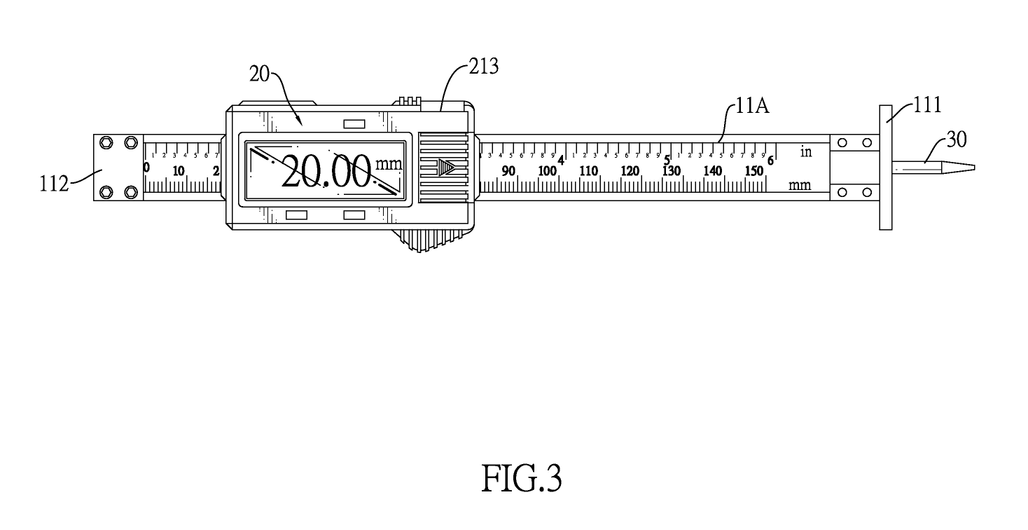

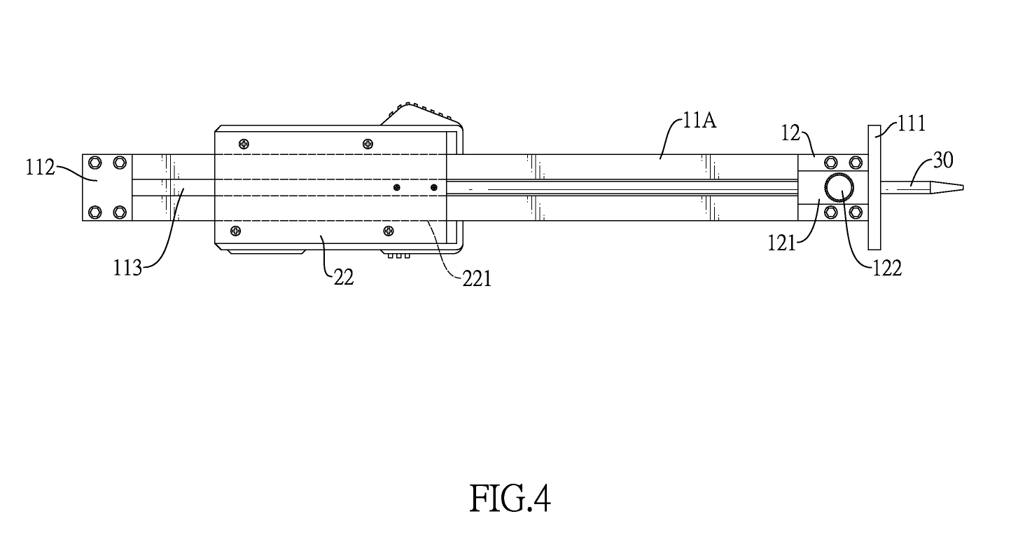

With reference to FIGS. 3 and 4, another embodiment of a measuring tool for buildings in accordance with the present invention has a plate 11A. The plate 11A has a side wall and a groove 113. The groove 113 is formed on a side wall of the plate 11A. The probe 30 is mounted in the groove 113 of the plate 11A. The positioning member 12 is mounted on the side wall of the plate 11A. The sharp end of the probe 30 is mounted through the stationary block 121 of the positioning member 12 and the pushing part 111 of the plate 11A and is moveable along the groove 113.

For identifying whether a thickness in a specific area of a fire resistant layer coated on a steel beam meets safety requirements, the measuring tool for buildings is implemented for a measuring process. The electronic reading device 20 is moved for a distance corresponding to a standard thickness along the plate 11, and the sharp end of the probe 30 is passed through the pushing part 111 over a length corresponding to the standard thickness. The resisting screw 122 of the positioning member 12 abuts the probe 30 to retain the probe 30 and the electronic reading device 20. The inspection personnel could measure various areas of the fire resistant layer by using the measuring tool. In the measuring process, when the sharp end of the probe 30 is inserted into the fire resistant layer and forms a measuring distance from the pushing part 111, the probe 30 is abutted by the resisting screw 122 to form a locked condition. So the thickness data can be precisely measured by the probe 30 without being affected by human errors.

The measuring instrument 21 of the electronic reading device 20 senses the moving distance along the plate 11. The moving distance of the electronic reading device 20 is the same as an insertion thickness of the probe 30 into a fire resistant layer. The accurate thickness data is shown on the screen 211 to eliminate erroneous reading, and the measuring data of thickness can be transmitted to a terminal device by the communication port 213. The terminal device is a computer, a server, or a flash disk. The thickness data of the fire resistant layer could be recorded completely and the measuring process of the measuring tool for buildings is operable by one person. The measuring tool for buildings is time-saving and manpower-saving. The multiple buttons 12 respectively have functions of power switch, zeroing adjustment, and unit conversion. Two opposite side walls of the measuring instrument 21 can be formed as two non-smooth walls for easy grasp by the inspection personnel in a measuring process. So the inspection personnel can easily move the measuring instrument 21 along the plate 11.

The limiting part 112 of the plate 11 is designed to selectively abut the electronic reading device 20 to prevent the electronic reading device 20 from escaping from the plate 11 of the body 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A measuring tool for buildings comprising:
a body having
a plate being elongated in an axial direction, and having
two ends; and
a pushing part formed on one of the ends of the plate;
an electronic reading device slidably mounted on the plate of the body and selectively moved along the plate of the body; and
a probe connected to the electronic reading device and having
a sharp end mounted through the pushing part of the plate; and
a connecting end connected to the electronic reading device.

2. The measuring tool for buildings as claimed in claim 1, wherein
the electronic reading device has
a measuring instrument slidably abutting the plate, and having
a screen mounted on the measuring instrument; and
an installing base having
a recess slidably mounted around the plate of the body; and
a surface facing the plate and connected to the measuring instrument.

3. The measuring tool for buildings as claimed in claim 2, wherein
the electronic reading device has
multiple buttons mounted on the measuring instrument and disposed near the screen.

4. The measuring tool for buildings as claimed in claim 1, wherein
the electronic reading device has a communication port, and signal transmission of the communication port is via USB interface, wireless transmission, or wired transmission.

5. The measuring tool for buildings as claimed in claim 3, wherein
the electronic reading device has a communication port, and signal transmission of the communication port is via USB interface, wireless transmission, or wired transmission.

6. The measuring tool for buildings as claimed in claim 1, wherein
the body further has
a positioning member mounted on the plate, disposed near the pushing part, and having
a stationary block mounted on the plate, and having
a through hole formed through the stationary block and parallel with the axial direction of the plate, the through hole disposed around the sharp end of the probe; and
a threaded hole formed in the stationary block and communicating with the through hole;
a resisting screw mounted through and screwed with the threaded hole of the stationary block, and having
a resisting end selectively abutting the probe.

7. The measuring tool for buildings as claimed in claim 5, wherein
the body further has
a positioning member mounted on the plate, disposed near the pushing part, and having
a stationary block mounted on the plate, and having
a through hole formed through the stationary block and parallel with the axial direction of the plate, the through hole disposed around the sharp end of the probe; and
a threaded hole formed in the stationary block and communicating with the through hole;
a resisting screw mounted through and screwed with the threaded hole of the stationary block, and having
a resisting end selectively abutting the probe.

8. The measuring tool for buildings as claimed in claim 1, wherein
the plate has
a side wall; and
a groove formed on the side wall of the plate; and
the probe is slidably mounted in the groove of the plate.

9. The measuring tool for buildings as claimed in claim 7, wherein
the plate has a side wall and a groove, and the groove is formed on the side wall of the plate;
the probe is mounted in the groove of the plate; and
the positioning member is mounted on the side wall of the plate.

10. The measuring tool for buildings as claimed in claim 1, wherein
the plate has
a marking surface; and
scales marked on the marking surface of the plate.

11. The measuring tool for buildings as claimed in claim 9, wherein
the plate has
a marking surface; and
scales marked on the marking surface of the plate.

12. The measuring tool for buildings as claimed in claim 1, wherein
the body has a limiting part securely connected to the other end of the plate of the body and selectively abutting the electronic reading device.

13. The measuring tool for buildings as claimed in claim 11, wherein
the body has a limiting part securely connected to the other end of the plate of the body and selectively abutting the electronic reading device.
